(19) United States
(12) Patent Application Publication
(10) Pub. No.: US 2016/0267580 A1
(43) Pub. Date: Sep. 15, 2016

(54) System and Method of Determining the Line of Business for Corporate Payment Account Products

(71) Applicant: MasterCard International Incorporated, Purchase, NY (US)

(72) Inventors: Kenny Unser, Fairfield, CT (US); Serge Bernard, Danbury, CT (US)

(21) Appl. No.: 14/642,615

(22) Filed: Mar. 9, 2015

(51) Int. Cl. G06Q 40/00

(52) U.S. Cl. CPC G06Q 40/00

(57) ABSTRACT

A system, method, and computer-readable storage medium configured to determine the line of business for a corporate payment account.

### BACKGROUND

1. Field of the Disclosure

Aspects of the disclosure relate in general to commercial services. Aspects include a method and analysis platform to determine the line of business for a corporate payment account.

2. Description of the Related Art

A payment card is a card that can be used by an accountholder and accepted by a merchant to make a payment for a purchase or in payment of some other obligation. Payment cards include credit cards, debit cards, charge cards, prepaid cards, and Automated Teller Machine (ATM) cards. Payment cards provide the clients of a financial institution (“accountholders”) with the ability to pay for goods and services without the inconvenience of using cash.

Some companies issue authorized employees payment cards for their use in business. These “corporate payment accounts” allow goods and services to be procured without using a traditional purchasing (requisition) process. For example, a company may authorize an employee to use a payment card for corporate travel and expenses, gas for company vehicles, and the like.

Because payment cards are usually issued by banks or other financial institutions, rather than payment networks, the payment networks often do not know the name of the cardholder, the name of the company issued the corporate payment card, nor the line of business of the company issued the corporate payment card.

### SUMMARY

Embodiments include a system, device, method and computer-readable medium to determine the line of business for a corporate payment account.

The system includes a processor and a network interface. The network interface receives an account identifier indicating the corporate payment account with a network interface. The corporate payment account is associated with an issuer. The processor retrieves a spending account transaction history using the account identifier from a non-transitory computer-readable storage medium. the account transaction history containing transactions that occurred within a given time period. Each of the transactions has a transaction date and time, an amount paid, a merchant, a merchant category, a card presence identifier, and a geographic location of the purchase. The processor extracts an issuer identification number (IIN) and payment account portfolio definitions associated with the corporate payment account from the non-transitory computer-readable storage medium. The processor retrieves external data from the corporate payment account from the non-transitory computer-readable storage medium. The external data includes known portfolio information and firmographic information. The processor determines a line of business indicators from the account transaction history, known portfolio information, and firmographic information. The processor reduces the line of business indicators using multicolliniearity analysis to weigh the line of business indicators with the known portfolio information and firmographic information. The processor determines the line of business of the corporate payment account based on the reduced line of business indicators, and saves the line of business of the corporate payment account on to the non-transitory computer-readable storage medium with the corporate payment account.

### BRIEF DESCRIPTION OF THE DRAWINGS

FIG. 1 is a block diagram illustrating a payment network to determine the line of business for a corporate payment account.

FIG. 2 is an expanded block diagram of an exemplary embodiment of a server architecture of a payment network embodiment configured to determine the line of business for a corporate payment account.

FIG. 3 illustrate a process flow, from the perspective of a payment network, to determine the line of business for a corporate payment account.

### DETAILED DESCRIPTION

One aspect of the disclosure includes the realization that it would be useful for payment networks to know the line of business for a corporate payment account. Payment networks generally do not have detailed payment account product information for accountholders. Such payment networks are limited to higher level product information used to determine processing details like interchange rates. Without detailed product information like the line of business a corporate accountholder represents, there is a limit to the analytic applications of transaction data held by a payment network.

In the case of corporate payment accounts, such as those for corporate payment cards, it would be especially useful to know the line of business associated with a business payment account product. Such knowledge may be useful to combat fraud. Purchases that do not align with a corporate payment accountholder's line-of-business can be declined. In other embodiments, a company may wish to receive information about their customers, so they can better align their offerings to their clientele. In yet another embodiment, another company may want to know the line of business associated with their customers to identify the portion of their revenue associated with industry trade shows.

Another aspect of the disclosure includes the realization that transaction activity for individual cards or portfolios of cards may be used to determine the line of business for corporate payment account products.

Aspects of the disclosure include a method and system of determining the line of business for a corporate payment account. In some embodiments, the line of business may be used for fraud analysis for payment account transactions; in other embodiments, the line of business may be used to electronically produce business line reports. The business line reports can be saved to a non-transitory computer-readable medium, displayed on a display, printed by a printer, or transmitted to a user via a network interface.

The systems and processes are not limited to the specific embodiments described herein. In addition, components of each system and each process can be practiced independently and separately from other components and processes described herein. Each component and process also can be used in combination with other assembly packages and processes.

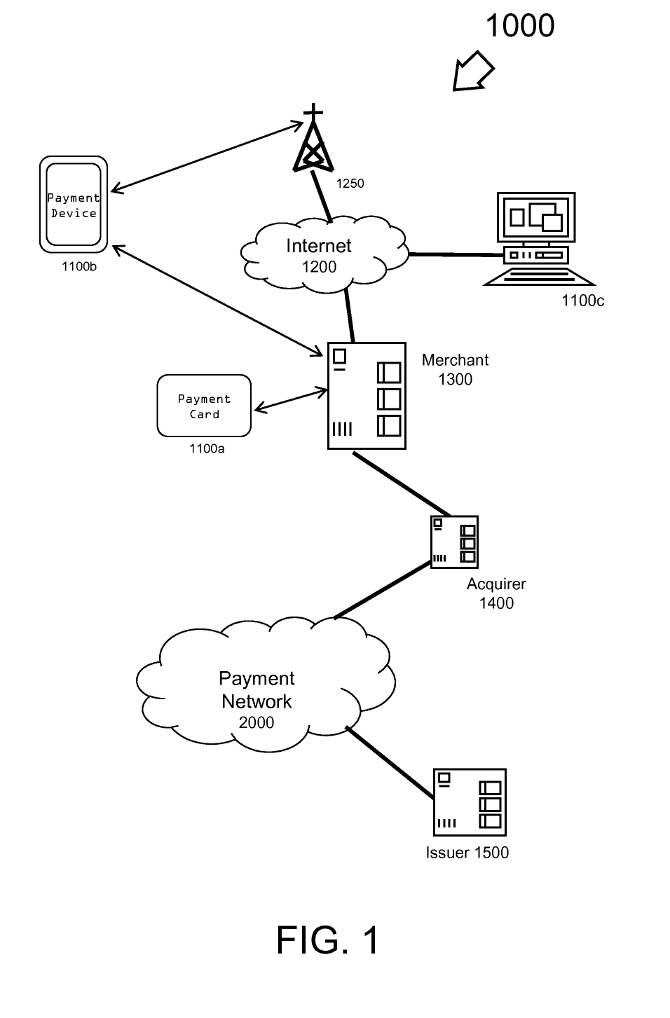

FIG. 1 is a block diagram 1000 illustrating a system and method to determine the line of business for a corporate payment account in a more efficient manner. The present disclosure is related to a payment network, such as a credit card payment system using a payment network 2000, such as the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system, a financial institution called the “issuer” 1500 issues a business payment account to a company. In a typical purchase transaction, issuer 1500 issues payment to an acquirer 1400 on behalf of its accountholder (the purchaser). In turn, the company may provide access to the payment account to an employee by issuing the employee a payment device 1100. The employee may use payment device 1100a-c to tender payment for a purchase from merchant 1300. Payment devices may include a payment card 1100a, mobile device 1100b (such as key fobs, mobile phones, tablet computers, Personal Digital Assistants (PDAs), electronic wallets and the like), or computers 1100c. Payment devices 1100 are associated with the payment account and may be used to tender purchase in-person at merchant 1300, or when connected via a mobile telephone network 1250 or the internet 1200.

In this example, a company employee makes a business purchase at merchant 1300; the sale may include goods or services. The company employee presents the payment device 1100 to a point-of-sale device at merchant 1300. The merchant 1300 is affiliated with a financial institution. This financial institution is usually called the “acquiring bank” “acquirer bank,” or “acquirer” 1400. The term acquirer indicates that the financial institution accepts or acquires payment from the issuer financial institutions within a payment network association. The acquirer 1400 may be a merchant bank or a payment service provider (PSP). When a payment device 1100 is tendered at merchant 1300, the merchant 1300 electronically requests authorization from the acquirer 1400 for the amount of the purchase. The request is performed electronically with the business payment account information. For payment cards, the business payment account information may be retrieved from the magnetic stripe on a payment card or via a computer chip imbedded within the payment card 1100a. For other types of payment devices 1100b-c, the business payment account information may be retrieved by wireless methods, such as contactless communication like MasterPass® or via Near Field Communication (NFC). The account information is forwarded to transaction processing computers of the acquirer 1400. Alternatively, an acquirer 1400 may authorize a third party to perform transaction processing on its behalf. In this case, the merchant 1300 will be configured to communicate with the third party. Such a third party is usually called a “merchant processor” or an “acquiring processor” (not shown).

The computers of the acquirer 1400 or the acquiring processor communicate, via payment network 2000, with the computers of the issuer bank 1500 to determine whether the business payment account is in good standing. It is understood that any number of issuers 1500 may be connected to payment network 2000.

Payment network 2000 provides fraud scoring for payment account transactions. Fraud scoring refers to an indication, or likelihood, that a payment transaction is fraudulent. In one fraud scoring system, the payment card network provides a number back to the payment card issuer between zero and 1,000, which translates into zero and 100 percent, in tenths of percentage points. In one embodiment, if the line of business of a corporate payment account is known, payment network 2000 may factor the line of into the fraud scoring. In such an embodiment, a purchase that its not consistent with the line of business is scored as more likely to be fraudulent than a consistent purchase. For example, suppose the line of business of a hypothetical corporate payment account is consumer electronics. Purchases of large amounts of agricultural commodities or farming equipment would be inconsistent with the consumer electronics industry, and therefore scored as more likely to be fraudulent.

Issuer 1500 evaluates the transaction based on the transaction information and the fraud score produced by payment network 2000. If the issuer 1500 approves the transaction, the approval is transmitted to the merchant, and the transaction is allowed.

After a transaction is captured, a clearing process occurs.

Eventually, the transaction is settled between the merchant 1300, the acquirer 1400, and the issuer 1500.

In situations where the line of business for a corporate payment account is unknown, payment network 2000 can determine the line of business based on the history of transactions with the payment card account, the geographic location of purchases, product purchase information, and other firmographic information. More details of the determination process are described below.

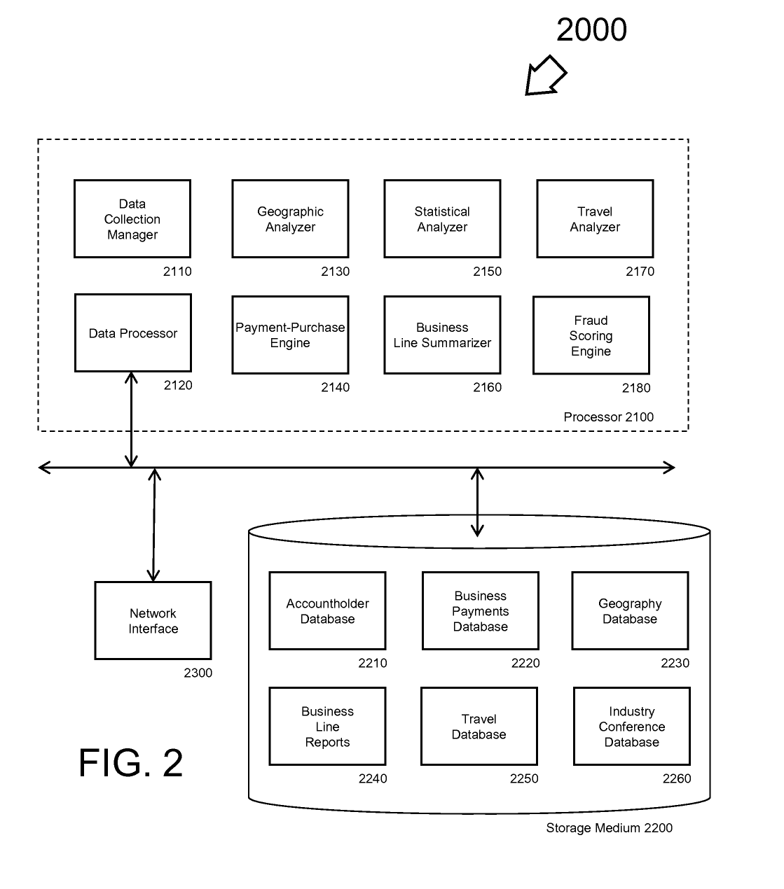

Embodiments will now be disclosed with reference to a block diagram of an exemplary payment network server 2000 of FIG. 2, configured to determine the line of business for a corporate payment account, constructed and operative in accordance with an embodiment of the present disclosure. While payment network server is described as being part of payment network 2000, it is understood that in some embodiments the payment network server described herein could be located at an issuer 1500.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a data collection manager 2110, a data processor 2120, a payment-purchase engine 2140, a fraud scoring engine 2180, a geographic analyzer 2130, statistical analyzer 2150, travel analyzer 2170, and a business line summarizer 2160.

Data processor 2120 interfaces with storage medium 2200 and network interface 2300. The data processor 2120 enables processor 2100 to locate data on, read data from, and writes data to, these components.

Payment-purchase engine 2140 performs payment and purchase transactions, and may do so in conjunction with data collection manager 2110 and fraud scoring engine 2180.

Data collection manager 2110 is the structure that facilitates consolidation and correlation of accountholder information. While in some embodiments data collection manager 2110 may receive the information directly from merchant 1300 or issuer 1500, it generally receives data from various databases described below.

Geographic analyzer 2130, statistical analyzer 2150, and travel analyzer 2170 are analysis engines. Geographic analyzer 2130 is configured to analyze the geographic locations of purchases made by an accountholder, and may do so with a geography database 2230. Travel analyzer 2170 is the structure configured to analyze the travel purchased by an accountholder, and may do so with data from a travel database 2250 and an industry conference database 2260. Statistical analyzer 2150 is an engine configured to statistically analyze portfolios of payment accounts or individual payment accounts with known lines of business to identify the factors used to determine a line of business. Statistical analyzer 2150 may correlate, regress, cluster, decision tree analyze, CHi-squared Automatic Interaction Detection (CHAID), or index the factors used to reduce the factors to those most indicative of a line of business. The statistical analyzer 2150 is configured to reduce the factors to those that are most indicative of line of business. For example, statistical analyzer 2150 may reduce the contribution of multiple, similar factors through multicollinearity analysis, or weigh the factors so that the factors that are most determinative of line of business are factored more heavily than “softer” factors.

Business line summarizer 2160 is configured to determine the business line of a corporate payment account, which are saved in an accountholder database 2210, and generate business line reports 2240. Business line summarizer 2160 embodiments receives the factors from the statistical analyzer 2150 and summarizes them to provide quantifiable probabilities that a payment account may belong to a line of business. In some embodiments, the probability accuracies are verified by using “holdout” samples of payment accounts with known line of business. The business line reports 2240 can be saved to a non-transitory computer-readable medium, displayed on a display (not shown), printed by a printer (not shown), or transmitted to a user via a network interface 2230.

These structures may be implemented as hardware, firmware, or software encoded on a computer readable medium, such as storage medium 2200. Further details of these components are described with their relation to method embodiments below.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain an accountholder database 2210, a business payments database 2220, a geography database 2230, business line reports 2240, a travel database 2250, and an industry conference database 2260. Accountholder database 2210 contains “internal data” information about a corporate payment account, including payment accounts (and their Primary Account Numbers) associated with an accountholder, an account transaction history, and any information collected by the data collection manager 2110. The internal data refers to data internal to the payment network. Business payments database 2220 is configured to store example expenditures from a known business account associated with a known line of business. A geography database 2230 stores the addresses and location of merchants 1300, allowing payment network 2000 to determine the physical location of a purchase transaction. A travel database 2250 is configured to store information related to the travel industry; specifically, embodiments store flight schedule information allowing payment network 2000 to determine the origination and destination of flights purchased. An industry conference database 2260 is configured to store known industry conferences so that payment network 2000 can correlate travel originations and destinations with travel to industry conferences. Business line reports 2240 are the generated output of business line summarizer 2160.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with acquirer 1400 and issuer 1500.

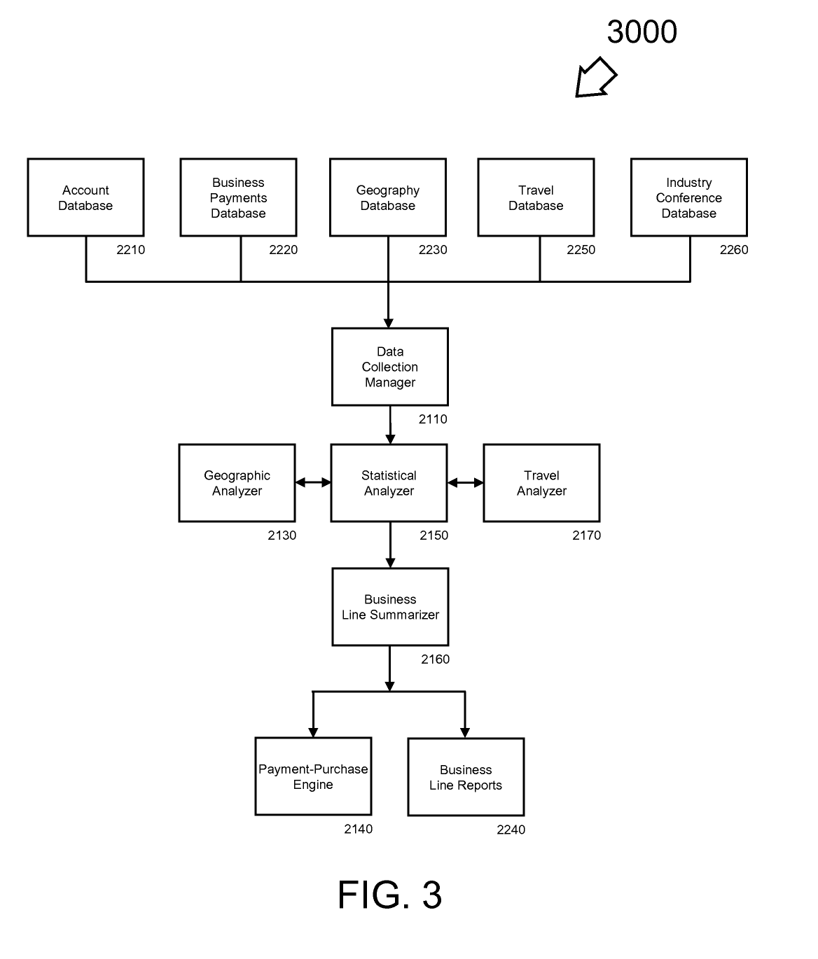

We now turn our attention to a method or process flow embodiment of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 illustrates a process flow 3000, from the perspective of a payment network server 2000, to determine the line of business for a corporate payment account, constructed and operative in accordance with an embodiment of the present disclosure. It is understood by those familiar with the art that process flow 3000 can be a batch process or a real-time process. In fraud analysis embodiments, process flow 3000 operates in real-time; in business line report embodiments the process flow 3000 can be a batch process.

Initially, an account identifier is provided to payment network 2000. The account identifier, which could be a Primary Account Number (PAN), is used to indicate the corporate payment account of interest. The Primary Account Number is a number specified by the International Organization for Standardization (ISO) 7812, and commonly printed on the face of a payment card. To determine the line of business for a corporate payment account, initially data collection manager 2110 retrieves the account information for the payment account in question from an accountholder database 2210. Accountholder database 2210 may be indexed based on the account identifier, and the account information is retrieved using the account identifier.

The account information includes information specific to the corporate payment account and an account transaction history. The account transaction history contains transactions that occurred within a given time period, which may be a subset or all of the transactions that have occurred with the payment account.

Information specific to an account includes the issuer 1500, and payment account portfolio definitions, such as that payment accounts with a certain product code are corporate products, and knowledge that payment accounts within a range of Bank Identification Numbers (BINs) are corporate products issued to employees of a single business. Sometimes called the Issuer Identification Number (IIN), the Bank Identification Number is a six-digit number that is part of the Primary Account Number, and is used to identify the institution and portfolio of the issuer 1500 that issues the payment device. Payment accounts are assigned a product code that captures information used by the payment network 2000 to determine interchange rates. Payment accounts related to reward payment cards, for example, have a higher interchange charge than payment accounts related to non-rewards payment cards. Attributes associated with product codes include a designation of whether the payment account is a business or consumer product. Product information (such as product types, consumer versus corporate, premium versus standard) are all attributes of the product code.

An account transaction history is a history of the transactions that have taken place for the payment account. Each transaction in the transaction history includes, but is not limited to: a transaction date and time, an amount paid, the merchant 1300 (identified by a merchant identifier), geographic location of purchases, card presence versus remote payments (i.e. online and merchant information), merchant category (wholesale or retailer classifications), and transaction addendum data. Transaction addendum data includes airline data (i.e, origin or destination location). From the transactions data, the data collection manager 2110 may also derive amount and frequency of purchase information, including attributes of the product code, i.e., product information (such as product types, consumer versus corporate, premium versus standard).

Additionally, the data collection manager 2110 receives “external” data from business payments database 2220, geography database 2230, travel database 2250, and industry conference database 2260. External data is information that is external to the payment account. The external data may include, but is not limited to:

Known Portfolio Information—examples include, but are not limited to:

### Example 1

An issuing bank provides information for splitting their corporate products into business entities.

### Example 2

A corporation provides a list of their corporate payment accounts.

### Example 3

A third party provides the line of business associated with a list of individual corporate payment accounts registered in an affinity program.

Firmographic Information—Information related to the concentration of industries in a geographic area. Examples include, but are not limited to:

### Example

Silicon Valley geographic definition where technology businesses are abundant.

### Example

Madison Avenue geographic definition where advertising and marketing companies are concentrated.

### Example

Financial districts of various cities (i.e. downtown New York City).

### Example

The U.S. automobile industry has a large presence in a geographic center surrounding Detroit.

Information related to supply chain for various industries, for example:

### Example

Steel is commonly sourced in Pennsylvania and from distributors sourcing Japanese steel in certain West Coast cities.

### Example

Lumber is commonly sourced from mills in the Pacific Northwest, Western Maine, and several places in Canada.

### Example

German goods tend to be received by importers at certain ports on the US Eastern seaboard.

Industry Events (ex. Trade Shows)

### Example

Outdoor Retailer is the largest trade show for outdoor equipment manufacturers. It occurs each September in Salt Lake City.

### Example

The largest consumer electronics trade show occurs in January each year in Las Vegas.

Once the information has been retrieved from the databases, data collection manager 2110 compiles and summarizes the transaction history and external information and forwards the compiled summary to statistical analyzer 2150.

As described above, statistical analyzer 2150 correlates, regresses, clusters, decision tree analyzes, CHi-squared Automatic Interaction Detection (CHAID), or indexes the factors used to summarize or reduce the factors to those most indicative of a line of business. In doing so, statistical analyzer 2150 is configured to identify indicators for corporate payment accounts individually or as part of a group. Individual identification is the determination that the payment account is a corporate product. Group identification is the determination that a plurality of payment accounts are all associated with a single entity.

Statistical analyzer 2150 may identify business-line indicators through product codes used to identify corporate payment accounts, or through analysis of a combination of internal data indicators. Such indicators can include but may not be limited to:

Bank Identifiers—such as an Interbank Card Association code, a four digit number that identifies a financial institution in a transaction process.

Portfolio Identifiers—such as Bank Identification Number ranges and product codes.

Account Vintage—a block of payment accounts issued in a certain date range.

In addition to the indicators, the statistical analyzer 2150 analyzes behavioral similarities and input from external sources. Behavioral similarities analyzes and compares the payment account with other payment accounts with common spend patterns, and payment accounts that are used to make certain purchases specific to a company (for example, purchases in a company store or cafeteria). Input from external sources include data from issuer 1500 participation, corporate payment account owner information, and list services.

For potential business lines, statistical analyzer 2150 summarizes a line of business indicators. The line of business indicators are potentially useful pieces of information that can help identify the line of business associated with a corporate payment account. Portfolios or individual payment accounts with known line of business to identify the factors that can be used to determine line of business.

Line of business indicators may include indicators determined by travel analyzer 2170 or geographic analyzer 2130.

Travel analyzer 2170 can determine whether there is plane fare or a hotel reservation associated with one or more transactions, as it would be more likely that the corporate payment accountholder is transacting during a business trip.

Geographic analyzer 2130 specializes in analyzing the location of transactions and their applicability in determining the line of business. Geographic analyzer applies transaction location information to geographic location information from the geography database 2230 to determine the location of a transaction. From this, transactions determined to be local to the business can reveal the likely industry. For example, a business located in Palo Alto, Calif. is more likely to be a technology business while a business located in southern West Virginia is more likely to be involved in mining. In another example, suppose a business payment account is used on trips to various locations where building materials are distributed (Pennsylvania steel towns, lumber mills) and to Peoria, Ill., where heavy machinery companies are headquartered, it is more likely that the line of business for that corporate payment account involves building or building supply.

Another business line indicator is whether a transaction was made near the headquarters or residence of the corporate payment accountholder versus during a business trip. If there are a number of entertainment expenses concentrated in a single geographic area without any lodging or travel related expenses, it is more likely that those transactions occurred near the business's location. These transactions may represent spend associated with hosting business contacts.

In some situations, the seasonality of business expenditures may indicate seasonal behavior associated with a line of business. For example, payment account users may attend trade shows at certain times of the year promoting their annual product lines. In another example, certain industries may renegotiate deals with their suppliers around the same time each year. In yet another example, product research and development with certain manufacturers may occur on an annual cycle.

The amount and frequency of expenditures may also be indicative of a line of business. In some industries, an expense account is a job perk. In such industries, higher ticket and higher frequency transactions may be observed. These transactions may occur at more upscale merchants. In contrast, in austere industries like government or educational institutions, per diems will be lower as will be the quality of merchants (such as budget hotels, budget airlines, basic dining).

Once statistical analyzer 2150 summarizes a line of business indicators, the indicator results are forwarded to the business line summarizer 2160. Business line summarizer 2160 reduces the factors to those that are most indicative of a line of business. Using multicollinearity analysis, the business line summarizer 2160 reduces the contribution of multiple, similar factors. The factors are weighed so that the factors that are most determinative of line of business are factored more heavily than “softer” factors. The factors are summarized into models that used to provide quantifiable probabilities that a card may belong to a line of business, and applied to the given payment account.

In one example, if a corporate payment account is observed to make local entertainment purchases around San Francisco with frequent business trips to Japan and an annual trip to Las Vegas during the Consumer Electronics Show (CES), it is likely that the payment card was issued to an employee of a technology company.

If a corporate payment accountholder is seen travelling to Midwestern towns during the Northern Hemispshere during their harvest season and Southern Hemisphere during their harvest season, the payment account may be likely to be involved in the distribution of perishable agricultural goods, for example.

In another example, a corporate payment account is observed to make local transactions in downtown Manhattan and travel to London, Geneva, Singapore, and Hong Kong. The cardholder also appears to be in cities during major banking conferences. The payment account may be in a finance industry line of business.

When a group of payment accountholders known to be associated with the same corporate entity are observed to transact in non-overlapping rural regions. These payment accountholders perform transactions at the same time four times a year: in March, June, September, and December in Peoria, Ill. It is likely that these payment accountholders are regional sales representatives in the farming industry and may represent a farm equipment manufacturer headquartered in Peoria.

The business line summarizer 2160 can check the accuracy of the models by applying “holdout” samples of payment accounts with known line of business.

In some embodiments, the business line summarizer 2160 may distribute line of business predictions. For example, in such an embodiment, business line reports 2240 are generated indicating line of business predictions or higher level summaries of corporate spending trends by line of business. For example, a Las Vegas hotel and casino may want to know the line of business associated with their guests to identify the portion of their revenue associated with industry tradeshows versus tourism. In another example, a marketer may wish to receive information about the customers of a particular merchant so they can better align their offerings to their clientele. For example, a hotel that attracts a lot of technology sector employees may want to advertise their high speed internet access. As mentioned above, the business line reports 2240 can be saved to a non-transitory computer-readable medium, displayed on a display, printed by a printer, or transmitted to a user via a network interface 2300.

In another embodiment business line summarizer 2160 can be used in real-time to determine whether a payment transaction involving a payment account is consistent with a known line of business. When the payment transaction is inconsistent with the known line of business, the fraud score calculated by payment network 2000 will indicate a higher likelihood of fraud. For example, suppose that a payment account was previously determined to have a line of business in electronics. If the current payment transaction relates to farm equipment, the fraud score will indicate a higher likelihood of fraud. However, if the current payment transaction relates to travel to Silicon Valley, for example, the payment transaction will be consistent with the electronics industry, and the fraud score will indicate a lower likelihood of fraud.

In some embodiments, purchases that do not align with a corporate payment accountholder's line-of-business can be automatically declined. For example, it may be deemed unusual for a financial services executive to make purchases at a wholesale chemical supply warehouse. In contrast, the same purchase may not arouse suspicion if the cardholder is believed to work in manufacturing.

### Example Use Embodiment

It is understood that the system described herein may be applied to a variety of different applications. This section describes a non-limiting example flow.

In this example, a list of corporate payment account numbers is provided by a client for a line-of-business determination by payment network 2000. The data collection manager 2110 retrieves “internal” data from accountholder database 2210, and receives “external” data from business payments database 2220, geography database 2230, travel database 2250, and industry conference database 2260. The data collection manager 2110 collects and summarizes the data, and forwards it on to geographic analyzer 2130, statistical analyzer 2150, and travel analyzer 2170.

Based on the spending history and internal data retrieved from accountholder database 2210, and geography database 2230, the geographic analyzer 2130 identifies two of the account numbers as being issued to cardholders based out of Palo Alto, Calif. A data store of probability factors assigns a high probability that corporate accounts from Palo Alto, Calif. are associated with businesses in the technology sector.

Statistical analyzer 2150 performs a deeper analysis on the card list. The deeper analysis leverages historical transaction data from both the payment account histories and spending patterns of known payment accounts in various business lines, from business payments database 2220. The travel analyzer 2170 looks at travel behavior using “level 3” airline data and merchant location information. The location and spend habits of each accountholder are summarized in ways that may be meaningful, including the locations and dates of travel, industries in which the accountholder transacted, and frequency and total expenditures.

For the first corporate account, travel analyzer 2170 identifies that travel itineraries include: visits to a technology manufacturing region of China and a handful of major cities; there were technology industry conferences in three of the cities visited that coincide with the dates of stay in those cities. During visits to the cities hosting technology conferences, there were some transactions that indicate participation in the conferences. For example, travel analyzer 2170 identifies hotel stays in the hotel hosting the conference, and purchases at the cafeteria of the convention hall hosting the conference.

For the second corporate account, statistical analyzer 2150 matches purchase patterns to derive indicators indicative of a line of business. Indicators would include expenditures such as large ticket purchases at uniform supply companies, commercial laundries, commercial appliance stores, and wholesale distributors of food service items, summertime purchases at tent and party rental services, and purchases at wholesale seafood and meat merchants that frequently occur on Friday and Saturday afternoons.

Business line summarizer 2160 determines that probability factors related to the first corporate account spend activity support the initial assessment that this card is likely to have been issued to an employee of the technology sector.

Business line summarizer 2160 determines that probability factors related to second corporate account spend activity refute the initial assessment that this card is likely to have been issued to an employee of the technology sector. Based on spend behavior, it is more likely that the accountholder is employed as a caterer or event planner.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A real-time method to identify the line of business of a corporate payment account, the method comprising:
receiving, with a network interface, an account identifier indicating the corporate payment account, the corporate payment account associated with an issuer;
retrieving, with a processor, an account transaction history using the account identifier from a non-transitory computer-readable storage medium, the account transaction history containing transactions that occurred within a given time period, each of the transactions having a transaction date and time, an amount paid, a merchant, a merchant category, a card presence identifier, and geographic location of the purchase;
extracting, with the processor, an issuer identification number (IIN) and payment account portfolio definitions associated with the corporate payment account from the non-transitory computer-readable storage medium;
retrieving external data from the corporate payment account from the non-transitory computer-readable storage medium, the external data including known portfolio information and firmographic information;
determining, with the processor, a plurality of line of business indicators from the account transaction history, known portfolio information, and firmographic information;
reducing the plurality of line of business indicators with the processor using multicolliniearity analysis to weigh the line of business indicators with the known portfolio information and firmographic information;
determining, with the processor, the line of business of the corporate payment account based on the reduced line of business indicators;
saving the line of business of the corporate payment account on to the non-transitory computer-readable storage medium with the corporate payment account.

2. The method of claim 1,
wherein each of the transactions further comprises transaction addenda;
the method further comprising:
analyzing, with the processor, the transaction addenda to identify corporate travel, the corporate travel including an origination location and a destination location.

3. The method of claim 2, wherein the external data further includes industry events.

4. The method of claim 3, wherein determining the line of business indicators includes matching, with the processor, the destination location with the industry events.

5. The method of claim 4, further comprising:
factoring, with the processor, the line of business of the corporate payment account into a fraud score of a purchase transaction using the corporate payment account;
transmitting, with the network interface, the fraud score of the purchase transaction to the issuer of the corporate payment account.

6. The method of claim 4, further comprising:
generating a business line report, with the processor, based on the line of business of the corporate payment account to a user.

7. The method of claim 5, wherein the reducing the line of business indicators from the account transaction history uses correlation, regression, clustering, decision tree analysis, CHi-squared Automatic Interaction Detection (CHAID), or indexing.

8. A real-time system to identify the line of business of a corporate payment account, the system comprising:
a network interface configured to receive an account identifier indicating the corporate payment account with a network interface, the corporate payment account associated with an issuer;
a processor configured to:
retrieve a spending account transaction history using the account identifier from a non-transitory computer-readable storage medium, the account transaction history containing transactions that occurred within a given time period, each of the transactions having a transaction date and time, an amount paid, a merchant, a merchant category, a card presence identifier, and a geographic location of the purchase;
extract an issuer identification number (TIN) and payment account portfolio definitions associated with the corporate payment account from the non-transitory computer-readable storage medium;
retrieve external data from the corporate payment account from the non-transitory computer-readable storage medium, the external data including known portfolio information and firmographic information;
determine a line of business indicators from the account transaction history, known portfolio information, and firmographic information;
reduce the line of business indicators using multicolliniearity analysis to weigh the line of business indicators with the known portfolio information and firmographic information;
determine the line of business of the corporate payment account based on the reduced line of business indicators;
save the line of business of the corporate payment account on to the non-transitory computer-readable storage medium with the corporate payment account.

9. The system of claim 8,
wherein each of the transactions further comprises transaction addenda; and
the processor is further configured to analyze the transaction addenda to identify corporate travel, the corporate travel including an origination location and a destination location.

10. The system of claim 9, wherein the external data further includes industry events.

11. The system of claim 10, wherein determining the line of business indicators includes matching, with the processor, the destination location with the industry events.

12. The system of claim 11,
wherein the processor is further configured to factor the line of business of the corporate payment account into a fraud score of a purchase transaction using the corporate payment account; and
the network interface is further configured to transmit the fraud score of the purchase transaction to the issuer of the corporate payment account.

13. The system of claim 11, further comprising:
generating a business line report, with the processor, based on the line of business of the corporate payment account to a user.

14. The system of claim 12, wherein the reducing the line of business indicators from the account transaction history uses correlation, regression, clustering, decision tree analysis, CHi-squared Automatic Interaction Detection (CHAID), or indexing.

15. A non-transitory computer-readable medium encoded with data and instructions, when executed by a computing device the instructions cause the computing device to:
receiving, with a network interface, an account identifier indicating the corporate payment account, the corporate payment account associated with an issuer;
retrieve, with a processor, a spending account transaction history using the account identifier from a non-transitory computer-readable storage medium, the account transaction history containing transactions that occurred within a given time period, each of the transactions having a transaction date and time, an amount paid, a merchant, a merchant category, a card presence identifier, and a geographic location of the purchase;
extract, with the processor, an issuer identification number (TIN) and payment account portfolio definitions associated with the corporate payment account from the non-transitory computer-readable storage medium;
retrieve external data from the corporate payment account from the non-transitory computer-readable storage medium, the external data including known portfolio information and firmographic information;
determine, with the processor, a line of business indicators from the account transaction history, known portfolio information, and firmographic information;
reduce the line of business indicators with the processor using multicolliniearity analysis to weigh the line of business indicators with the known portfolio information and firmographic information;
determine, with the processor, the line of business of the corporate payment account based on the reduced line of business indicators;
save the line of business of the corporate payment account on to the non-transitory computer-readable storage medium with the corporate payment account.

16. The non-transitory computer-readable medium of claim 15,
wherein each of the transactions further comprises transaction addenda; and
wherein the processor is further configured to analyze the transaction addenda to identify corporate travel, the corporate travel including an origination location and a destination location.

17. The non-transitory computer-readable medium of claim 16, wherein the external data further includes industry events.

18. The non-transitory computer-readable medium of claim 17, wherein determining the line of business indicators includes matching, with the processor, the destination location with the industry events.

19. The non-transitory computer-readable medium of claim 18, the instructions further causing the computing device to:
factor, with the processor, the line of business of the corporate payment account into a fraud score of a purchase transaction using the corporate payment account;
transmit, with the network interface, the fraud score of the purchase transaction to the issuer of the corporate payment account.

20. The non-transitory computer-readable medium of claim 18, the instructions further causing the computing device to:
generate a business line report, with the processor, based on the line of business of the corporate payment account to a user.
